(19) United States
(12) Patent Application Publication
(10) Pub. No.: US 2009/0276075 A1
(43) Pub. Date: Nov. 5, 2009

(54) METHOD AND SYSTEM FOR MONITORING A PREDICTED PRODUCT QUALITY DISTRIBUTION

(76) Inventors: Richard Good, Austin, TX (US); Matthew Purdy, Austin, TX (US)

Correspondence Address: WILLIAMS, MORGAN & AMERSON, 10333 RICHMOND, SUITE 1100, HOUSTON, TX, 77042, US

(21) Appl. No.: 12/366,211

(22) Filed: Feb. 5, 2009

(30) Foreign Application Priority Data
Apr. 30, 2008 (DE) 10 2008 021 557.0

(51) Int. Cl. G06F 19/00; G06N 5/02; G06F 17/10

(52) U.S. Cl. 700/110; 706/46; 703/2

(57) ABSTRACT

In a complex manufacturing environment for producing semiconductor devices, a predicted quality distribution in the form of a graded die forecast may be monitored with respect to changes in order to more efficiently identify factory disturbances. To this end, a predicted distribution obtained on the basis of electrical measurement data may be compared with a predicted yield distribution based on other production data. That is, an efficient automatic monitoring of the manufacturing environment may be accomplished with reduced probability of missing respective disturbance situations, since the large number of electrical parameters may be condensed into the predicted quality distribution.

### BACKGROUND OF THE INVENTION

1. Field of the Invention

Generally, the present disclosure relates to the field of fabricating integrated circuits, and, more particularly, to the monitoring of process flow quality and production yield by evaluating measurement data.

2. Description of the Related Art

Today's global market forces manufacturers of mass products to offer high quality products at a low price. It is thus important to improve yield and process efficiency to minimize production costs. This holds especially true in the field of semiconductor fabrication, since, here, it is essential to combine cutting-edge technology with mass production techniques. It is, therefore, the goal of semiconductor manufacturers to reduce the consumption of raw materials and consumables while at the same time improve process tool utilization. The latter aspect is especially important since, in modern semiconductor facilities, equipment is required which is extremely cost-intensive and represents the dominant part of the total production costs. Consequently, high tool utilization, in combination with a high product yield, i.e., with a high ratio of good devices to faulty devices, results in increased profitability.

Integrated circuits are typically manufactured in automated or semi-automated facilities, thereby passing through a large number of process and metrology steps to complete the devices. The number and the type of process steps and metrology steps a semiconductor device has to go through depends on the specifics of the semiconductor device to be fabricated. A usual process flow for an integrated circuit may include a plurality of photolithography steps to image a circuit pattern for a specific device layer into a resist layer, which is subsequently patterned to form a resist mask used in further processes for forming device features in the device layer under consideration by, for example, etch, implantation, deposition, polish and anneal processes and the like. Thus, layer after layer, a plurality of process steps are performed based on a specific lithographic mask set for the various layers of the specified device. For instance, a sophisticated CPU requires several hundred process steps, each of which has to be carried out within specified process margins so as to fulfill the specifications for the device under consideration. Since many of these processes are very critical, a plurality of metrology steps have to be performed to efficiently monitor and control the process flow. Typical metrology processes may include the measurement of layer thickness, the determination of dimensions of critical features, such as the gate length of transistors, the measurement of dopant profiles, the number, the size and the type of defects, electrical characteristics, such as the transistor drive current, the threshold voltage thereof, i.e., the voltage at which a conductive channel forms in the channel region of a field effect transistor, the transconductance, i.e., the change of drive current with gate voltage, and the like. As the majority of the process margins are device-specific, many of the metrology processes and the actual manufacturing processes are specifically designed for the device under consideration and require specific parameter settings at the adequate metrology and process tools.

In a semiconductor facility, a plurality of different product types are usually manufactured at the same time, such as memory chips of different design and storage capacity, CPUs of different design and operating speed and the like, wherein the number of different product types may even reach one hundred and more in production lines for manufacturing ASICs (application specific ICs). Since each of the different product types may require a specific process flow, different mask sets for the lithography, specific settings in the various process tools, such as deposition tools, etch tools, implantation tools, chemical mechanical polishing (CMP) tools, metrology tools, and the like, may be necessary. Consequently, a plurality of different tool parameter settings and product types may be encountered simultaneously in a manufacturing environment, thereby also creating a huge amount of measurement data, since typically the measurement data are categorized in accordance with the product types, process flow specifics and the like.

Hereinafter, the parameter setting for a specific process in a specified process tool or metrology or inspection tool may commonly be referred to as process recipe or simply as recipe. Thus, a large number of different process recipes, even for the same type of process tool, may be required which have to be applied to the process tools at the time the corresponding product types are to be processed in the respective tools. However, the sequence of process recipes performed in process and metrology tools or in functionally combined equipment groups, as well as the recipes themselves, may have to be frequently altered due to fast product changes and highly variable processes involved. As a consequence, the tool performance in terms of throughput and yield are very critical manufacturing parameters as they significantly affect the overall production costs of the individual devices. Therefore, great efforts are made to monitor the process flow in the semiconductor facility with respect to yield-affecting processes or process sequences in order to reduce undue processing of defective devices and to identify flaws in process flows and process tools. For example, at many stages of the production process, inspection steps are implemented for monitoring the status of the devices. Moreover, other measurement data may be generated for controlling various processes, in which the measurement data may be used as feed forward and/or feedback data.

With reference to FIGS. 1a-1b, a typical manufacturing environment for producing semiconductor products will now be described so as to discuss further problems related to the efficient estimation of the product quality during the manufacturing of semiconductor devices.

FIG. 1a schematically illustrates a manufacturing environment 150 which is to represent a facility configured to produce semiconductor products at least to a certain stage of completeness, for instance to a stage in which fully functional semiconductor devices are provided on substrates while, for instance, additional fabrication processes, such as the separation into individual semiconductor chips, the packaging thereof and the like, may be performed in other manufacturing environments. The environment 150 comprises a plurality of process tools and metrology tools, which may frequently be grouped into functional modules in which certain types of related process steps may be performed. For example, the environment 150 may comprise a plurality of process modules 160A, 160B, 160C, wherein each module may comprise a plurality of process tools and metrology tools as required for performing a plurality of related manufacturing processes. For instance, the process module 160A may represent a plurality of process tools and metrology tools which may be used for performing sophisticated lithography processes in combination with corresponding pre-exposure and post-exposure processes, development of resist material and the like. In other process modules, complex etch processes may be performed on the basis of appropriate process tools, possibly in combination with respective cleaning processes and the like, as may be required by the overall process strategy. In other cases, deposition tools may provide the capability of depositing and forming material layers with a high degree of controllability on the basis of thermally activated deposition techniques, such as low pressure chemical vapor deposition (CVD), oxidation and the like. In other process modules, implantation tools may be provided which may typically be used for incorporating any desired species, such as dopant species for modifying the conductivity of semiconductor regions and the like. Consequently, the modules 160B, 160C may represent a plurality of appropriate process tools for performing at least one manufacturing process in accordance with a predefined process recipe, wherein the recipe may change in the same process tool depending on the product type to be processed, as previously explained. It should be appreciated that dividing the manufacturing environment 150 into respective process modules may be arbitrary and may depend on the overall configuration of the manufacturing environment under consideration. Furthermore, it should be appreciated that typically a plurality of the manufacturing processes may be associated with appropriately designed metrology processes so as to monitor and control the results of the previously performed processes. Furthermore, the manufacturing environment 150 may comprise an “interface” 190 that is typically provided in the form of an automated or semi-automated transport system which interconnects the various process modules 160A, 160B, 160C in order to supply substrates to be processed and to receive substrates that have been processed in the corresponding process tools or metrology tools. For this purpose, the process modules 160A, 160B, 160C and the transport system 190 may be operated such that a desired high overall throughput of the manufacturing environment 150 may be accomplished by supplying the various product types according to their current manufacturing stage to the process modules 160A, 160B, 160C, as is required for the next step in the overall manufacturing flow. For example, on the right-hand side of FIG. 1a, a typical process flow for forming sophisticated semiconductor devices on the basis of CMOS technology is illustrated, wherein the various process stages shown may be reached by being processed in the one or more process modules 160A, 160B, 160C at least once, while typically the products may be passed through the various process modules several times, wherein the corresponding process recipes may be adapted to the desired process results to be obtained in the corresponding manufacturing stage.

For example, substrates 151 may have formed thereon a plurality of die regions 152, each of which may represent a semiconductor device including a very large number of individual circuit elements, such as transistors, capacitors, resistors and the like, as is required for the desired functional behavior of the semiconductor product under consideration. For convenience, the die regions 152 may also be referred to as semiconductor devices. As an example of a circuit element, a field effect transistor 153 may be referred to in order to demonstrate a typical overall manufacturing process. In the manufacturing stage shown, the field effect transistor 153 may comprise a gate electrode 153A, which is formed above a semiconductor region 153B and separated therefrom by a gate insulation layer 153C. As is well known, the operational behavior of the transistor 153 may be substantially determined by the characteristics of the gate electrode 153A and the gate insulation layer 153C, as also explained above. That is, the length of the gate electrode 153A, i.e., in FIG. 1a, the horizontal extension of the gate electrode 153A in combination with the material composition and the thickness of the gate insulation layer 153C, may have a significant influence on the overall controllability of a conductive channel that forms in the semiconductor region 153B at the gate insulation layer 153C upon application of an appropriate control voltage to the gate electrode 153A. Similarly, a vertical dopant profile in the semiconductor region 153B, that may have previously been established prior to the formation of the gate electrode 153A, may also have a significant influence on electrical characteristics of the transistor 153, for instance with respect to threshold voltage, current drive capability and the like. Consequently, since the operational behavior of the individual transistors 153 may have a significant influence on the final operational behavior of the semiconductor device 152, for instance with respect to overall speed, a precise control of the manufacturing techniques for forming the gate electrodes 153A, the gate insulation layer 153C and the like, may be required. For example, respective processes for forming the gate electrode 153A may be accomplished on the basis of manufacturing processes performed in at least some of the process modules 160A, 160B, 160C. For example, forming the transistor 153 as shown in this early manufacturing stage, indicated as stage I, may include sophisticated lithography techniques for forming trenches for isolation structures (not shown) and subsequently depositing appropriate materials, such as silicon dioxide, silicon nitride and the like, in accordance with specified deposition recipes. Thereafter, excess material may be removed, for instance by CMP, and thereafter a dielectric material may be formed, for instance by deposition and/or oxidation, in accordance with the requirements for forming the gate insulation layer 153C. Next, the gate electrode material may be deposited and thereafter a further sophisticated lithography process may be performed to provide an appropriate etch mask for patterning the gate electrode 153A and the gate insulation layer 153C.

In a later manufacturing stage II, the transistor 153 may, for instance, comprise a sidewall spacer structure 153D, which may be used for defining an appropriate vertical and lateral dopant profile for drain and source regions 153E. Since the spacer structure 153D, at various intermediate manufacturing stages, may be used as an implantation mask for defining the profile of the regions 153E, the dimensions of the spacers 153E, in combination with the implantation processes, may also have a significant influence on the overall electrical characteristics of the transistor 153. For example, respective manufacturing processes involved in forming the transistor 153A as shown in the manufacturing stage II may involve the deposition of appropriate spacer materials, such as silicon nitride, possibly in combination with etch stop materials, such as silicon dioxide and the like, which may be subsequently etched in order to obtain the spacer structure 153D with a width as required for profiling the regions 153E. Thereafter, an implantation process may be performed to introduce the dopant species on the basis of appropriate implantation parameters, such as implantation energy and dose, followed by anneal processes for activating the dopants and curing implantation-induced damage.

It should be appreciated that, prior to and after the manufacturing stage II or prior to and after the manufacturing stage I, various manufacturing processes may also have to be performed in accordance with the overall process strategy to obtain the desired transistor performance. For instance, for transistors in the deep sub-micron range, control of short channel effects may require extremely thin insulation layers which may have a thickness of 1-2 nm for silicon dioxide-based materials, which in turn may result in increased leakage currents through the gate dielectric material. Hence, further device scaling may require the incorporation of high-k dielectric materials and/or appropriate adaptation of the overall dopant profiles in the channel region of the transistor 153 to obtain an acceptable threshold voltage and maintain channel controllability, which, however, may result in a reduction of the channel conductivity. Thus, frequently, intentional strain may be created in the channel regions of the transistors in order to enhance the electron mobility to provide enhanced transistor performance for scaling the device dimensions, while the thickness of the gate dielectric material may be maintained at a thickness considered acceptable in view of leakage currents. Thus, a plurality of strain-inducing mechanisms may be employed wherein, for instance, for P-channel transistors, an appropriate semiconductor alloy may be incorporated, for instance in and/or adjacent to the channel region, in order to obtain a desired type of strain. Hence, in this case, additional complex manufacturing techniques may be required, the process results of which may also have a significant influence on the finally obtained electrical characteristics of the transistor 153.

In stage III, the semiconductor device 152 is illustrated in a further advanced manufacturing stage in which a contact structure 154 and a metallization system 155 may be provided. For example, the contact structure 154 may include an interlayer dielectric material, such as silicon dioxide and the like, in order to enclose the transistors 153, wherein respective contact elements may connect to contact areas of the transistors 153, such as the drain and source regions 153E and the gate electrode 153A. The metallization system 155 may comprise a plurality of metallization layers, wherein, for convenience, a first metallization layer 155A and a subsequent metallization layer 155B are illustrated. In the metallization layers 155A, 155B, respective metal lines and vias are provided to establish the overall required connection of the circuit elements, such as the transistors 153, in accordance with the overall circuit layout. It should also be appreciated that the characteristics of the contact structure 154 and the metallization system 155 may have a significant influence on the overall electrical performance of the semiconductor device 152. For example, in sophisticated semiconductor devices having critical dimensions of 0.1 μm, for instance with respect to gate length, the signal propagation delay in the metallization level 155 may also play an important role and may even be more critical than a corresponding signal propagation delay in the device level. Consequently, complex manufacturing strategies have been developed, for instance by replacing with copper or copper alloys and also using low-k dielectric materials in order to reduce the parasitic RC time constants in the metallization system 155. The handling of copper in the environment 150, as well as the usage of low-k dielectric material, which have typically reduced mechanical stability compared to conventional dielectrics, such as silicon dioxide, silicon nitride and the like, may require advanced manufacturing strategies which may also have a significant influence on the overall electrical performance. For example, in addition to requiring a specified electrical behavior, the metallization system 155 may also have to exhibit a certain performance with respect to electromigration in order to guarantee a specific device performance over a specified lifetime. The electromigration behavior of metal features in the metallization system 155 may significantly depend on the materials used, such as conductive and dielectric barrier materials, dielectric interlayer materials and the like, as well as the fabrication processes used, which may thus require a thorough monitoring of the processes involved in the fabrication of the metallization system 155.

FIG. 1b schematically illustrates the environment 150 when processing substrates 151 according to one or more specified manufacturing flows for respective product types. For example, it may be assumed that the substrates 151, which may typically be handled in the environment 150 in certain groups or lots, may represent a specific product type, such as a CPU, a memory device and the like, which may thus be processed in the environment 150 by passing the substrate 151 one or several times through the process modules 160A, 160B, 160C, as previously explained. The entire sequence of process steps may be referred to as a manufacturing flow 170, which may comprise a plurality of sequences 170A, 170B, 170C which, for instance, may be performed in the corresponding modules 160A, 160B, 160C according to appropriate process recipes corresponding to the respective manufacturing stage, as previously explained. Typically, respective manufacturing processes 171 may be associated with a corresponding metrology process 172, at least in many of the sequences 170A, 170B, 170C, in order to monitor and control the overall process quality. For example, in the sequence 170A, the metrology process 172 may provide measurement data which may be used for controlling the associated manufacturing process or processes 171, for instance by providing a corresponding feedback control loop. For example, upon measuring the line width of resist features after exposing and developing a resist material for forming an etch mask for patterning the gate electrodes 153A, the exposure dose of the lithography process may be adjusted for subsequent substrates to be processed, thereby providing an efficient feedback control mechanism.

However, since a plurality of further manufacturing processes may be involved for forming a corresponding resist mask, such as pre-exposure baking, post-exposure baking, spin-coating of the resist material, accuracy of the alignment process and the like, and due to the fact that the measuring of the process output may be performed on the basis of selected samples in view of overall throughput of the environment 150, a certain degree of variability of the process output may nevertheless occur. Furthermore, due to the restricted amount of measurement data, since not all die regions 152 of each substrate can be measured for economical reasons, typically, predictive control algorithms may be used, in particular when a certain degree of delay is involved in obtaining the measurement data, in which the process results may be calculated on the basis of measurement data and the tool settings may be predicted for a currently being processed product to obtain the desired outcome. Furthermore, respective measurement results obtained in one sequence 170A may also be used in other processes still to be performed, thereby providing a respective feed forward control mechanism. Typically, the overall process flow 170 may be controlled on the basis of a supervised control system, such as an MES (manufacturing execution system), which is responsible for the appropriate material supply and initialization of the appropriate process recipe at the various process tools. Thus, after completing the manufacturing flow 170, which may include several hundred individual process steps, the substrate 151 may have formed thereon the semiconductor devices 152, wherein, however, across the various substrates 151 and also within each individual substrate 151, a variation of the finally obtained electrical characteristic of the devices 152 may be observed. For this reason, a final electrical test for obtaining representative electrical characteristics of the devices 152 may be performed for each of the devices 152 of each substrate 151 leaving the environment 150, which is typically referred to as electrical wafer sort process, wherein the corresponding electrical characteristics, such as operating speed in the form of a ring oscillator frequency, current drive capability, overall power consumption, access time for memory cells, the amount of available storage in storage devices or CPU cache areas, threshold voltage of transistors, may be determined, which is a time-consuming process. Furthermore, the respective electrical characteristics may be used to determine a yield or quality distribution for the devices 152 for the plurality of substrates 151, for instance with respect to certain quality specifications, such as speed grade and the like.

Consequently, in view of economic reasons, the environment 150 should provide a high throughput with a quality distribution in accordance with specific customer demands. Although the environment 150 may include a plurality of efficient control mechanisms in the form of metrology processes and respective control strategies, such as APC (advanced process control) strategies, the environment 150 may represent a complex organism in which even subtle changes in some parts of the “organism” may result in a significantly different final quality distribution of the electrical characteristics, which may finally define the overall functional behavior of the semiconductor devices under consideration. For example, due to the complexity of the manufacturing flow 170, a non-desired quality distribution may be obtained, even though the individual sequences 170A, 170B, 170C may be within the predefined process margins. For example, it is very difficult to assess the influence of the various manufacturing processes due to the complex mutual interaction on the finally obtained quality distribution. If, for example, a different quality distribution may be required on short notice due to customer demand, it may be difficult to assess whether or not the respective quality distribution may be achieved on the basis of the currently being processed substrates, or it may be very difficult to decide how to change the process targets for the various sequences in view of the new desired quality distribution.

Thus, great efforts are made in monitoring the overall behavior of the manufacturing environment, for instance by measuring electrical characteristics with short delay to the critical manufacturing steps for selected samples (sample wafer electrical test, SWET), which may, however, require the monitoring of a large number of parameters, thereby possibly missing signals that may indicate a disturbance. On the other hand, it may be very difficult to decide whether certain SWET indicated disturbances are critical for the final quality of the completed device. Hence, in combination, this strategy may result in missing critical SWET signals, thereby contributing to a reduction in quality, while on the other hand the investigation of “false” SWET disturbances may waste engineering resources or may cause a reduction of the overall throughput.

The present disclosure is directed to various methods and systems that may avoid, or at least reduce, the effects of one or more of the problems identified above.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

Generally, the present disclosure relates to systems and techniques for monitoring the overall behavior of a complex manufacturing environment with respect to the finally produced quality of semiconductor products while significantly reducing the response time with respect to the occurrence of any disturbances that may have occurred during the processing of the semiconductor devices. To this end, a quality distribution may be assigned to at least a significant portion of product groups to be processed or being processed in the manufacturing environment, wherein the dynamic behavior of the quality distribution may be monitored so as to detect a disturbance within the manufacturing environment. The monitoring of the dynamic development of the quality distribution may comprise at least one measurement step producing electrical test data at a very advanced manufacturing stage of the semiconductor products, which may be obtained with reduced delay compared to electrical wafer sort data, which may typically be gathered after a significant time period after performing critical manufacturing steps that determine the quality of the semiconductor products. In some illustrative aspects disclosed herein, the predicted quality distribution obtained on the basis of the electrical test measurement data may be compared with the current predicted quality distribution, wherein a pronounced change may thus indicate the occurrence of a disturbance in the manufacturing environment. That is, the predicted quality distribution, which may be updated on the basis of intermediate measurement data, may therefore contain inherent information with respect to the mutual interaction of the various paths of the complex manufacturing environment, for instance with respect to local control strategies, process targets for the various process modules and the like, while the electrical measurement data may provide a moderately robust estimation of actual quality distribution so that a significant mismatch between the quality distribution prior to using the electrical measurement data and the quality distribution obtained by using the electrical measurement data may indicate an inconsistency, thereby providing the possibility of efficiently detecting the reason for the disturbance in a time-efficient manner without a significant delay, as may be caused in conventional strategies. Furthermore, a significant degree of data reduction may be accomplished by monitoring the predicted quality distribution, since the information contained in the large number of measurement data, for instance in electrical test measurement data, may be “compressed” into the quality distribution, for instance by using an appropriately defined model, thereby significantly enhancing the automatic monitoring of the dynamic behavior of the manufacturing environment and also enhancing the automatic identification of the occurrence of a disturbance while significantly reducing the probability of “missing” relevant information, as may be the case when a large number of electrical test parameters may have to be monitored and analyzed. The quality distribution, which is to be understood as a distribution of a quality metric with respect to at least a plurality of different die regions of the corresponding product substrates for at least one quality standard of the finally obtained semiconductor devices, may thus provide the desired information about the various facility-internal aspects, such as targeting the various process modules, hardware status of process tools, the quality of control mechanisms and the like, while the final updated quality distribution based on the electrical measurement data may act as a robust representation of the actual data of the manufacturing environment, since the electrical measurement data may include the relevant information with respect to substantially most of the manufacturing steps performed, while at the same time a high degree of intelligibility of the information may be provided.

One illustrative method disclosed herein comprises determining a first predicted quality distribution for a group of substrates prior to performing one or more manufacturing processes in a manufacturing environment, wherein each of the substrates comprises a plurality of die regions. The method further comprises obtaining electrical measurement data from one or more selected sample substrates of the group and determining a second predicted quality distribution on the basis of the electrical measurement data. Finally, the method comprises monitoring the manufacturing environment with respect to an occurrence of a disturbance by determining a deviation between the first and the second predicted quality distributions.

Another illustrative method disclosed herein comprises determining a predicted yield distribution for a process result of processing a group of substrates by performing a plurality of manufacturing processes in a manufacturing environment wherein each substrate comprises a plurality of semiconductor devices. The method further comprises receiving electrical measurement data in a data processing system from selected samples of the group after performing the plurality of manufacturing processes. Moreover, the method comprises updating the predicted yield distribution by using the electrical measurement data and a model implemented in the data processing system. Finally, the method comprises comparing the predicted yield distribution and the updated predicted yield distribution to monitor the manufacturing environment with respect to the occurrence of a disturbance.

One illustrative system disclosed herein comprises an interface configured to connect to an automatic test equipment for receiving measurement data, wherein the automatic test equipment provides electrical measurement data from substrates comprising semiconductor devices after completing a plurality of manufacturing processes. The system further comprises a yield prediction unit connected to the interface and configured to update a predicted yield distribution associated with product substrates to be processed by the plurality of manufacturing processes by using electrical measurement data obtained from selected samples of the substrates. Moreover, the system comprises an evaluation unit connected to the yield prediction unit and configured to determine a deviation of an updated yield distribution generated by the yield prediction unit from a non-updated yield distribution.

### BRIEF DESCRIPTION OF THE DRAWINGS

The disclosure may be understood by reference to the following description taken in conjunction with the accompanying drawings, in which like reference numerals identify like elements, and in which:

FIGS. 1a-1b schematically illustrate a manufacturing environment for processing substrates for forming semiconductor devices on the basis of a conventional strategy for determining the quality of the final products;

FIG. 2a schematically illustrates a manufacturing environment including a system for monitoring the dynamic behavior of the quality distribution for identifying disturbances, according to illustrative embodiments;

FIG. 2b schematically illustrates a mechanism implemented in the system of FIG. 2a, wherein a disturbance may be detected on the basis of a change of predicted quality distributions, according to illustrative embodiments;

FIG. 2c schematically illustrates a diagram in which representative data are illustrated for assessing the dynamic behavior of a manufacturing environment on the basis of the difference between quality distributions, according to illustrative embodiments;

FIGS. 2d-2f schematically illustrate diagrams representing mechanisms for identifying discrepancies between two different predicted quality distributions, according to further illustrative embodiments;

FIG. 2g schematically illustrates the system of FIG. 2a according to still a further illustrative embodiment in which a model monitor may be used for monitoring and updating one or more models used for generating respective predicted quality distributions; and

FIG. 2h schematically illustrates a respective output of the model monitor shown in FIG. 2g, according to illustrative embodiments.

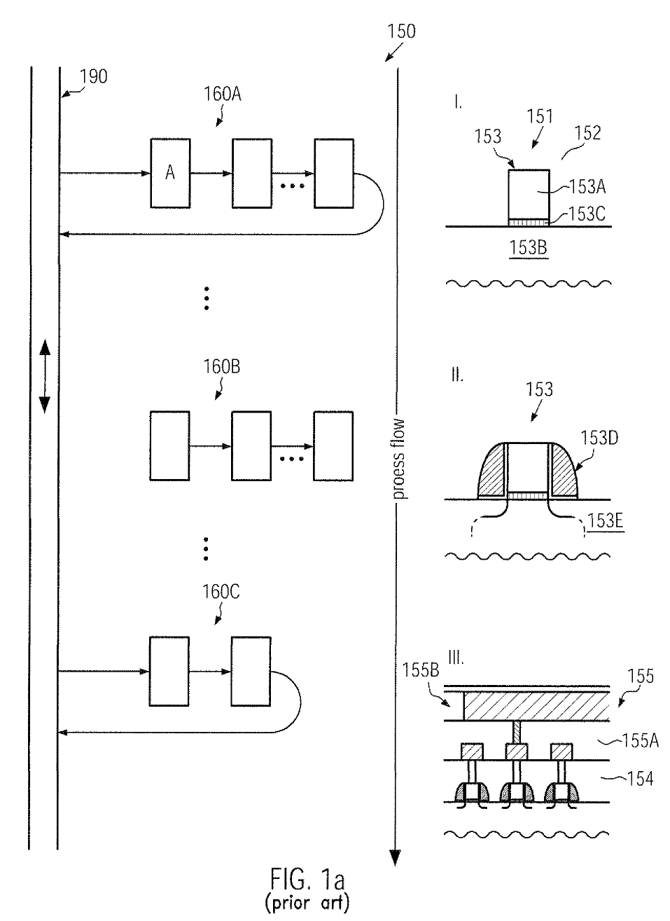

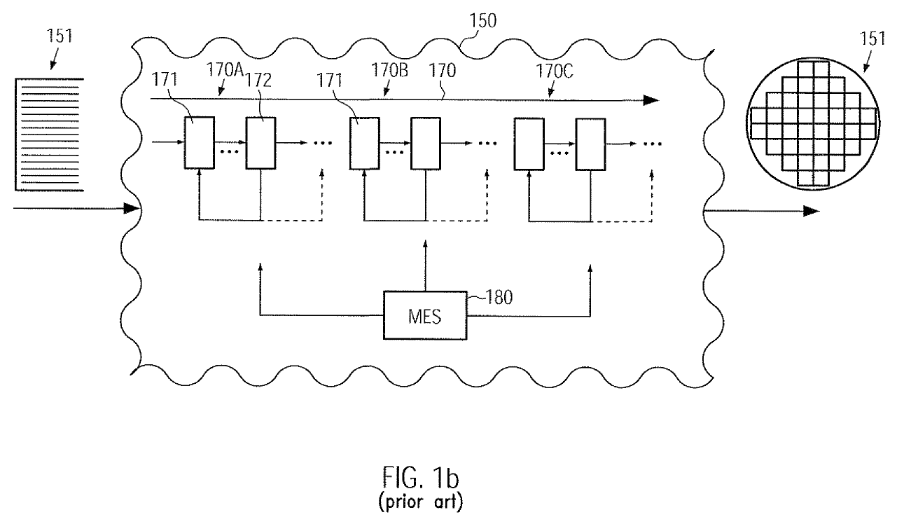

While the subject matter disclosed herein is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

Various illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present subject matter will now be described with reference to the attached figures. Various structures, systems and devices are schematically depicted in the drawings for purposes of explanation only and so as to not obscure the present disclosure with details that are well known to those skilled in the art. Nevertheless, the attached drawings are included to describe and explain illustrative examples of the present disclosure. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

Generally, the present disclosure provides a system and methods for monitoring the dynamic behavior of a complex manufacturing environment on the basis of predicted quality distributions, which may be assigned to at least a plurality of product substrates to be processed or being processed in the manufacturing environment. For this purpose, electrical measurement data obtained from some sample substrates after completing at least a significant portion of the manufacturing processes under consideration may be used to generate an updated predicted yield distribution, which may therefore include the information of the plurality of manufacturing processes in a highly “condensed” manner, while nevertheless providing a high degree of intelligibility of the information inherent in the electrical measurement data, thereby providing the potential for an efficient automatic monitoring of the overall behavior and thus of the mutual interaction of the various complex parts of the manufacturing environment under consideration. The predicted quality distribution may be understood as a representative metric for determining the expected yield at a specific die location across the substrates, which may also be referred to as a “graded” die forecast with respect to yield and thus quality of the semiconductor product under consideration. In some illustrative aspects, the yield distribution may refer to a single predefined quality standard or specification, that is, the resulting semiconductor product may have to respect a predefined quality standard so that the quality distribution may thus reflect a metric for the probability or the number of products having the specified quality standard may be obtained in the respective die location, when a plurality of substrates are considered. For instance, a complex central processing unit (CPU) may comprise a plurality of speed critical signal paths, possibly in combination with fast internal memory areas, such as cache memories, which may also have a significant influence on the overall performance of the CPU. Thus, the finally obtained storage capacity of the cache memory may represent one quality criterion and the frequency with which the CPU core may be reliably operated may also present a further quality criterion, wherein, in combination, the plurality of respective quality criteria may determine a specific quality grade of the CPU. Thus, quality distribution may relate to CPUs of a specific quality standard, while other quality standards, for instance lower-ranked semiconductor devices, may not be taken into consideration when establishing a respective predicted quality distribution. In other cases, complex analog circuitry may also be assessed on the basis of respective quality criteria and also storage devices may be divided into several quality categories, depending on the respective criteria, which may depend on company-internal decisions, customer demands and the like. It should be appreciated, however, that, in other illustrative embodiments, the predicted quality distribution may also accommodate two or more quality grades of the semiconductor device under consideration.

By assigning a predicted quality distribution to at least a plurality of product groups, which are currently being processed in the manufacturing environment, an assessment of the environment may be obtained with a degree of granularity, depending on product groups associated with a respective predicted quality distribution. For example, a corresponding predicted quality distribution may be assigned to each group of product substrates or generally to any group of product substrates to be processed in the manufacturing environment, at least for a desired time period, in order to provide enhanced statistical significance in identifying any disturbances of the manufacturing environment. That is, typically, a plurality of measurement data may be created when stepping the product groups through the plurality of manufacturing processes, as previously explained, wherein typically selected sample substrates may be subjected to measurement to obtain a compromise between overall throughput and controllability of the individual process steps. Typically, respective measurement samples may be selected from each product group so that the assignment of a respective predicted quality distribution to each group of product substrates may provide the potential for “refining” the predicted quality distribution on the basis of the available production data. Hence, in some illustrative aspects disclosed herein, the initial predicted quality distribution, which may be established, for instance, on the basis of averaged quality data of substrates after forming the final quality test measurements, may be updated by using the corresponding measurement data, wherein the updated version of the predicted quality distribution may now reflect the current status of a part of the manufacturing environment including the respective factory targets, control strategies, status of the production tools and the like. For example, when a group of products may arrive at a critical process module, such as a sequence of manufacturing processes for patterning a gate electrode, measurement data of the finally patterned gate length may be used for updating the predicted quality distribution assigned to the group of products prior to performing the critical gate patterning process, wherein, for instance, a known correlation or any appropriate model or any other mechanism may be used for determining an updated yield metric for each die grade. For instance, if measurement reveals that central die regions may be within the process targets with respect to the gate length, while a plurality of die regions at the substrate edge of the substrates may have an increased gate length, the corresponding yield metrics, such as percentages and the like, may be adopted so as to reduce the expectation for semiconductor products for these specific die grades due to the increased gate length created by the manufacturing sequence. Consequently, the updated quality distribution may now be regarded as the new “target” quality distribution for the specific group of substrates, which may then be further updated on the basis of further production data, thereby increasingly incorporating further production relevant information. It should be appreciated that, for instance, a significant deviation of measurement data of the process result of specific manufacturing processes may immediately be identified by the inline control strategies and monitoring algorithms, wherein, however, a moderately subtle change may remain undetected by the local internal control mechanisms. As an example, target values for the various critical process steps may have been established and may be used for the complex internal control strategies, such as APC (advanced process control) mechanisms, which may therefore attempt to maintain the process output at the specified target value. However, the respective target value may actually be offset by a certain amount from a “true” target value, which may, however, not be known in advance, or which may have shifted due to modifications of, for instance, the overall transistor architecture, layout specifics and the like. Consequently, although the local control mechanisms may be highly efficient in maintaining the corresponding manufacturing processes within respective process windows in order to obtain a distribution of process results centered around the predefined target value, the final electrical performance of the semiconductor device under consideration may not necessarily be correlated to the corresponding target value as may be expected. A corresponding “discrepancy” between actually used target values and respective “true” target values may be considered as a disturbance of the manufacturing environment, since this disturbance may result in a reduced overall yield for a specified quality grade. Similarly, responding to customer demands may also be difficult when a corresponding disturbance may remain undetected over extended time periods since, for instance, a respective customer demand may be expected to be met by the products currently in process, while the final products may have a significantly different quality distribution.

Consequently, the usage of sample wafer electrical test (SWET) data may be advantageous since these measurement data are typically obtained at a very late stage of the manufacturing process, for instance after completing one or more metallization levels, or may even provide similar electrical data as are obtained during the wafer sort process, in which each semiconductor device may undergo a respective electrical test procedure on the basis of which the quality grade of the respective semiconductor device may be evaluated prior to actually dicing the substrates and performing further process steps, such as packaging and the like. The respective electrical measurement data may, however, contain a plurality of individual parameters, such as sheet resistance values for various configurations, such as resistors, doped regions, strained semiconductor materials and the like, oscillator frequencies, drive currents of transistor devices, threshold voltage values, or any other current and voltage responses of corresponding test structures associated with each die region. Since the monitoring of a large number of electrical parameters, which implicitly may contain the information about the dynamic behavior of the manufacturing environment with respect to disturbances, may be difficult since corresponding “signals” indicating a prominent disturbance may be overlooked, while other signals may indicate a disturbance but may actually not be relevant for the final product quality. Consequently, according to the principles disclosed herein, the valuable electrical measurement data may be “reduced” by applying a model and determining a predicted quality distribution, which may then be compared to the previous predicted quality distribution so that a basic match of these distributions may indicate an appropriate overall behavior of the manufacturing environment, while a significant change may indicate a disturbance of the manufacturing environment. Consequently, by using an appropriate model, the received electrical measurement data may be automatically processed and analyzed, thereby providing an automatic monitoring system with respect to disturbances of the manufacturing environment, wherein, due to the electrical measurement data, a contemporary response to any disturbances may be accomplished while at the same time significantly reducing the probability of missing a respective factory disturbance, as may be the case in conventional strategies in which a plurality of electrical parameters are individually monitored.

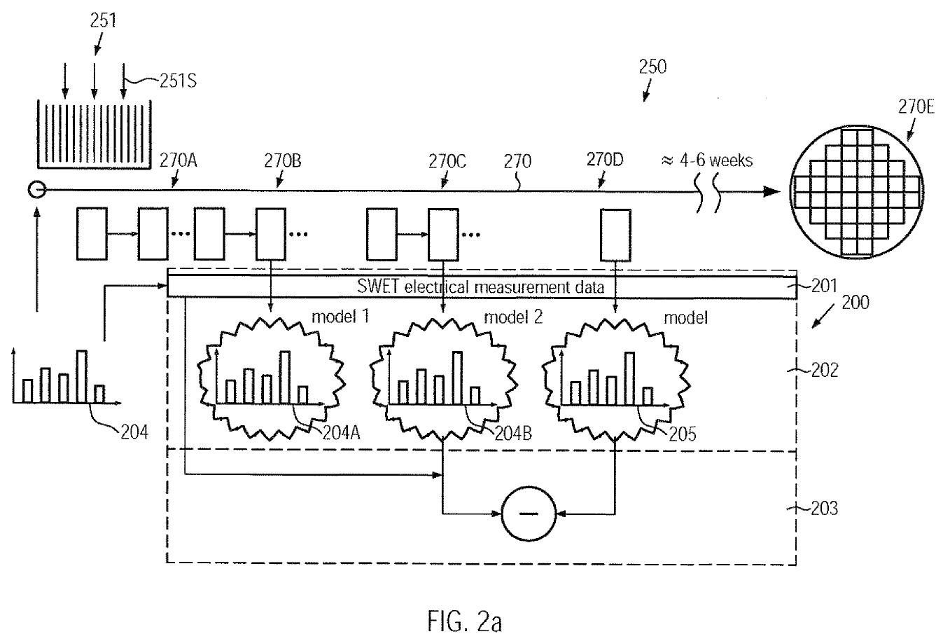

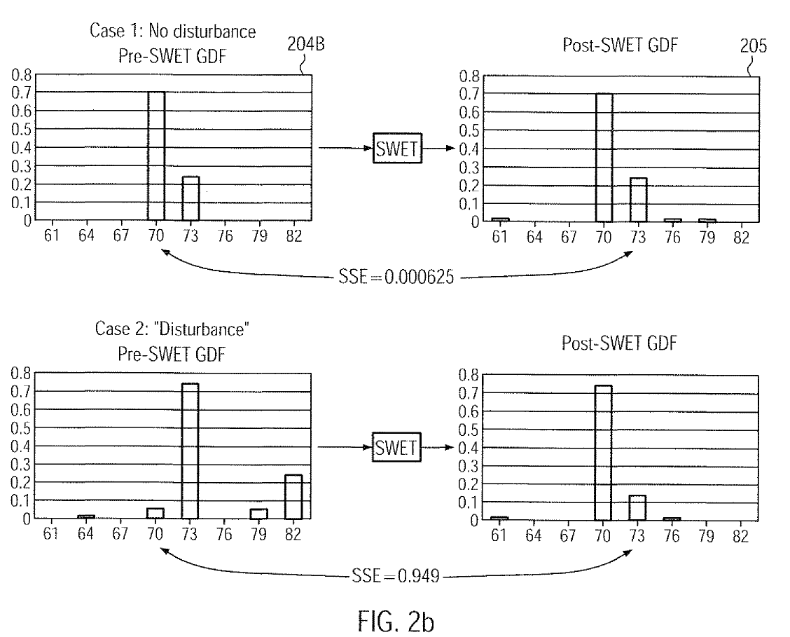

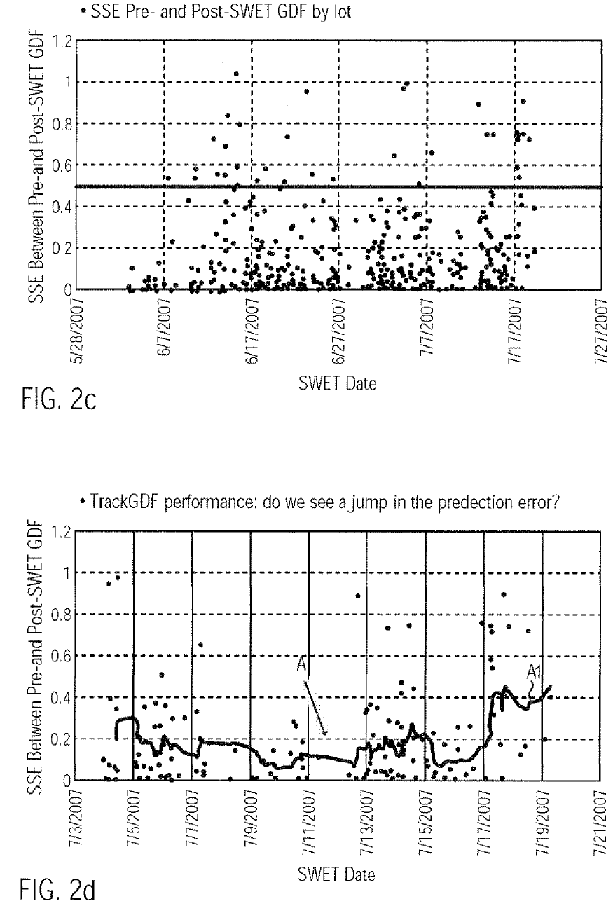

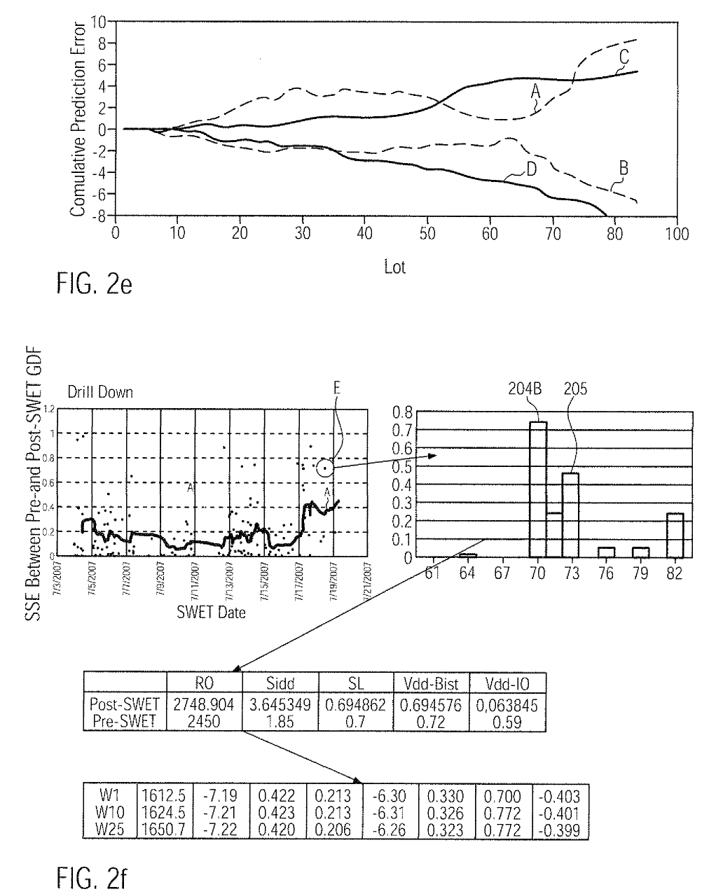

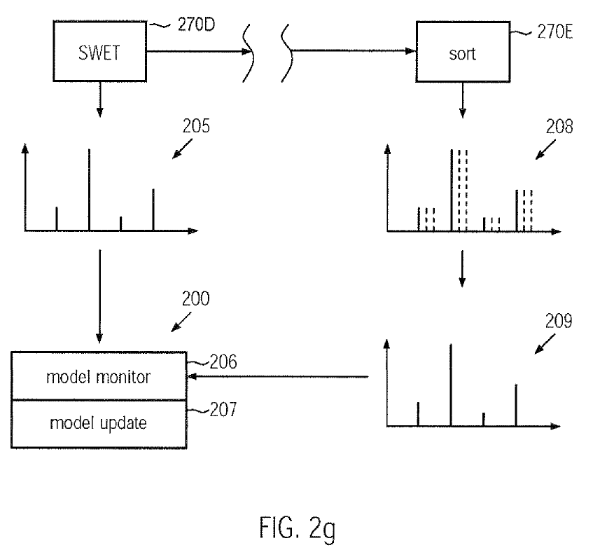

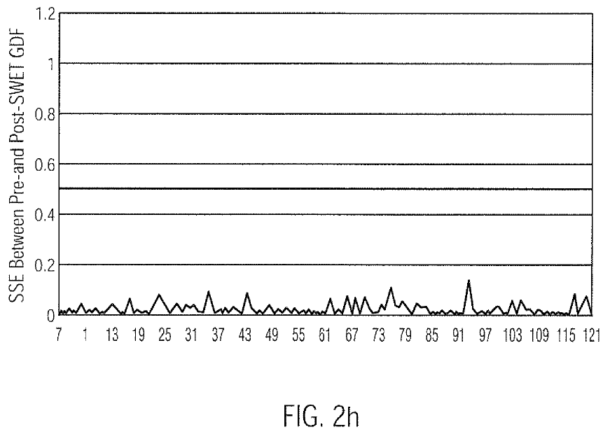

FIG. 2a schematically illustrates a manufacturing environment 250, which may comprise a plurality of manufacturing processes 270A, 270B, 270C, 270D including actual production processes and metrology processes. As previously explained with reference to the environment 150, the manufacturing processes, depending on the overall configuration of the facility under consideration, may be divided into functional entities or process modules, each of which may perform at least one production process, possibly in combination with “assisted” processes, such as cleaning and the like, wherein at least some of the corresponding functional groups may be associated with a respective metrology process, as previously explained. It should be appreciated, however, that the principles disclosed herein should not be considered as being restricted to any functional grouping of the manufacturing processes 270A, 270B, 270C, 270D. In the embodiment shown, the process 270D may represent a metrology process for generating electrical measurement data, which may include any desired electrical parameters, as previously explained. In one illustrative embodiment, the process 270D may represent a wafer electrical test process for performing test procedures as may also be performed on each of the semiconductor devices under consideration at a later manufacturing stage, however only for selected sample substrates. In other cases, the electrical measurement data 270D may comprise an intermediate electrical measurement data, which may be obtained during a respective manufacturing flow 270. Furthermore, the manufacturing environment 250 may comprise a manufacturing process and related process tools 270E for performing a final electrical test for each individual substrate and each individual semiconductor device formed thereon. It should be appreciated that the process 270E may, in some illustrative embodiments, not be a part of the manufacturing flow 270 and may even be performed in a different manufacturing environment, depending on the overall company-specific strategy. Furthermore, the manufacturing environment 250 may comprise a data processing system 200 that is configured to monitor the dynamic behavior of the environment 250 with respect to the occurrence of disturbances, as explained above. For this purpose, the system 200 may comprise an interface 201 that is configured to receive at least the electrical measurement data from the module 270D, which may be accomplished on the basis of any appropriate data link so as to directly connect to the module 270D or the interface 201 may be connected to a supervising control system of the environment 250, as previously explained. Moreover, the interface 201 may receive data representing a predicted quality distribution 204, which may represent the variation between a die and an expected metric for indicating the probability or the number of semiconductor devices obtained from the specific die position with respect to a predefined quality specification.

In some illustrative embodiments, the predicted quality distribution 204 may be provided by a supervising control system, which may be configured to control the overall supply of products, the selection and adaptation of process recipes for the respective process tools and the like, as previously explained. Furthermore, the system 200 may comprise a yield prediction unit 202 that is operatively connected to the interface 201 so as to receive therefrom the electrical measurement data in any appropriate format. The yield prediction unit 202 may be configured to operate on the electrical measurement data, also indicated as SWET data, on the basis of a model, which is implemented in the unit 202 and establishes a mechanism in which a new or updated quality distribution 205 may be created. That is, the unit 202 may comprise a mechanism for mapping the electrical measurement data SWET on a respective distribution 205, which may be accomplished by defining a respective transformation, which in turn may be determined on the basis of historic measurement data obtained from the module 270E and historical electrical measurement data obtained from previously processed substrates. For this purpose, for instance, any appropriate regression technique may be used, for instance least squares regression and the like. During a corresponding process for determining an appropriate model, well-established data processing techniques may be used in which appropriate coefficients for a respective transformation may be determined, which maps the independent variables, that is, the electrical measurement data SWET, to the dependent variables, i.e., the various yield metrics for the individual die grades. Due to the high degree of reliability of the electrical measurement data, the corresponding quality distribution 205 may be considered as a moderately robust representation of the quality distribution of a group of products, although only selected samples may have been used for obtaining the electrical measurement data.

Furthermore, the system 200 may comprise an evaluation unit 203, which may be connected to the unit 202 and the interface 201 so as to receive data corresponding to the quality distribution 205 established by the unit 202 and at least one quality distribution 204 that is based on any production relevant information except for the electrical measurement data SWET. The evaluation unit 203 may be configured to compare the predicted quality distributions 204 and 205 to identify a pronounced difference of these two distributions. For example, a predefined criterion may be implemented in the unit 203 for estimating the degree of difference between the distributions 204, 205, for instance in the form of a threshold, wherein exceeding the threshold may indicate a disturbance in the environment 250. For instance, respective threshold values may be defined and implemented in the unit 203 with respect to a desired statistical criterion in order to automatically detect a significant change, which may then be subjected to further data analysis, if required. For instance, the summed square error of both distributions 204, 205 may be used as an efficient statistical criterion for monitoring the dynamic behavior of the environment 250. For instance, a specified threshold may be defined which, when exceeded, may indicate a disturbance or at least a status of the environment 250, which may require further investigation.

During a production phase of the environment 250, a group of substrates 251, which may typically also be referred to as a lot, may be entered into the environment 250, wherein it should be appreciated that typically respective schedules may be associated with the group 251 in accordance with the overall policy for managing the environment 250. Also, other groups of products (not shown) may already be in production so that a substantially continuous stream of products may enter the environment 250 and may also leave the environment 250, thereby defining the overall throughput. As previously explained, in some illustrative embodiments, at least some of the groups 251 to be processed or being processed in the environment 250 may be associated with a predicted quality distribution, such as an initial distribution 204, which may be established on the basis of any default values, such as a mean quality distribution obtained from measurement data of the station 270E, as previously discussed. For this purpose, in some illustrative embodiments, a respective distribution for a specific number of die locations, i.e., die grades, may be established for one or more quality levels. For example, a respective graded quality distribution may be used in which fully operational semiconductor devices with the highest quality level may be taken into consideration for at least a plurality of die locations or all die locations across a substrate. During the processing of the group 251, in one or more of the process sequences or modules 270A, 270B, 270C, selected sample substrates 251S may be subjected to measurement procedures, thereby creating respective production-related measurement data, as previously explained. Thus, in some illustrative embodiments, the initial or default predicted quality distribution 204 may be updated on the basis of the corresponding production-related measurement data in order to obtain an updated quality distribution 204A. In the embodiment shown in FIG. 2a, it may be assumed that the process module 270B may create corresponding production-related measurement data, which may then be mapped into the distribution 204, which may be accomplished by the appropriate model, as previously discussed. The updated quality distribution 204A may be established at any appropriate component of the environment 250, for instance in a supervising control system having access to the production-related measurement data, in the module 270B itself and the like. In some illustrative embodiments, the production-related measurement data may be transmitted to the unit 202 via the interface 201 and the unit 202 may have implemented therein or may be configured to retrieve an appropriate model from a corresponding database (not shown) in order to obtain the updated quality distribution 204A. Similarly, during the further processing of the group 251, further production-related measurement data may be created, as is, for instance, shown with respect to the module 270C, thereby creating a further updated version 204B, thereby increasing the “incorporated” production-relevant information about the environment 250 into the most recent predicted distribution 204B. Also, in this case, the distribution 204B may be created by any appropriate component, for instance in the unit 202, as is also explained with reference to the distribution 204A. Similarly, further updated versions of the distribution 204 may be established, wherein each version may be based on the previous updated distribution. Thus, the most recent distribution 204B and the distribution 205 may be supplied to the evaluation unit 203 and may be compared, as previously explained, in order to monitor the dynamic behavior of the environment 250 with respect to disturbances, as previously explained.

FIG. 2b schematically illustrates a situation for substantially matching distributions 204B and 205, indicated as Case 1, wherein, for instance, a summed square error for the distribution 204B representing the state immediately prior to the process module 270D, i.e., the “SWET” station, and the distribution 205 may be moderately small, thereby indicating a high degree of consistency between both predicted quality distributions. On the other hand, in Case 2, both distributions 204B, 205 may have a significant deviation, as indicated by the moderately high error value, thereby indicating a disturbance. Consequently, the unit 203 may automatically detect disturbance situations by evaluating the distributions 204B, 205.

FIG. 2c schematically illustrates a diagram in which the dynamic behavior of the manufacturing environment 250 may be represented by the corresponding deviations between respective predicted distributions 204B and 205, as previously explained. In FIG. 2c, the horizontal axis represents the point in time of obtaining corresponding SWET measurement data for groups of products after passing the plurality of manufacturing processes 270A, 270B, 270c. The vertical axis represents the deviation associated with the corresponding groups of products. As illustrated, most of the deviations, for instance measured in the form of the summed square errors of the distributions 204B, 205, may be within a range between 0 and 0.2, while other values may indicate a more pronounced deviation. For example, a threshold may be defined so as to identify corresponding deviation values, which may represent possible factory disturbances, while, in other cases, additional data analysis techniques may be used for identifying significant changes in the dynamic behavior of the environment 250.

FIG. 2d schematically illustrates a diagram which may provide a more detailed view of a respective portion of the diagram of FIG. 2c in order to identify a pronounced change of the dynamic behavior. Also, in this case, the horizontal axis represents the point in time of obtaining the SWET data, while the vertical axis represents the degree of deviation of the corresponding distributions 204B, 205. In this case, a data processing mechanism may be implemented in the unit 202 to monitor an averaged time variation of the respective deviation values. For example, curve A may represent the time progression of the average deviations for each point in time so as to identify a pronounced change of the behavior of the environment 250. For example, as is illustrated, A1 may represent a portion of curve A at which a pronounced increase of the average deviation may occur, thereby more clearly indicating a disturbance of the environment 250.

FIG. 2e schematically illustrates a diagram representing a further example of a data manipulation mechanism, which may be used for monitoring the dynamic behavior of the environment 250. In the mechanism shown, a cumulative prediction error may be monitored for each or at least a plurality of different die grades, for instance with respect to the groups of products 251 that have been most recently processed in the environment 250. In the example shown, the final 86 groups are taken into consideration, thereby providing an efficient technique for monitoring the overall behavior of the environment 250. For instance, in FIG. 2e, the cumulative error for four die grades, indicated as bin 71, bin 73, bin 80, bin 82, are illustrated and are represented by curves A, B, C, D, respectively. As is evident from FIG. 2e, curve A may exhibit a pronounced increase after adding the respective prediction error of approximately 70 groups thereby indicating an “under prediction” of the respective die grade. Similarly, curve B, representing the die grade 73, may exhibit a significant change in its behavior, also at approximately 70, thereby indicating a certain degree of “over prediction” for this die grade. On the other hand, curves C and D may exhibit a substantially “steady” behavior thereby indicating a substantially stable prediction behavior of the corresponding die grades. Hence, also in this case, a corresponding disturbance may be detected in a highly efficient manner.

FIG. 2f schematically illustrates a further mechanism for analyzing “suspicious” candidates with respect to disturbances. For example, as shown, a respective candidate, indicated as E, of the distribution as shown in FIG. 2d may be selected for further analysis, which may be accomplished by explicitly referring to the corresponding distributions 204B, 205, wherein, for further analysis, the corresponding electrical measurement data may be retrieved, at least for the distribution 205, which has been established on the basis of the electrical measurement data. For the distribution 204B, the respective models' electrical data may be used. Upon further analysis, the measurement data for obtaining the distribution 204B may be retrieved, for instance by requesting the data from a supervising control system, when the corresponding distribution 204B may not have been established in the unit 202, as previously described. Consequently, by appropriately going back from the predicted distribution, a desired degree of “resolution” may be obtained in view of analyzing the “disturbance” situation represented by the candidate E. Consequently, a highly efficient and automatic monitoring system may be established, wherein any disturbances may be efficiently identified while, if required, appropriate analysis techniques may be used for providing enhanced robustness in actually indicating a disturbance, as, for instance, described above with reference to FIGS. 2d-2f.

FIG. 2g schematically illustrates a portion of the system 200, according to illustrative embodiments, in which a model monitor 206 may be provided in combination with a model update unit 207. The model monitor 206 may receive the respective predicted distributions 205 from the unit 202 and may also receive actual quality distributions obtained on the basis of measurement data obtained from the station 207D. That is, the station 207E may produce electrical test data for each of the substrates produced in the environment 250, however, with a significant delay of, for instance, several weeks, so that the corresponding final quality distribution 208 may be established, which may also include the various different degrees of quality, such as different speed grades, storage capacity and the like. That is, the overall final distribution 208 may comprise, in addition to the quality level or levels used in the predicted quality distributions 204, 205, any intermediate quality level, thereby also containing the corresponding defective devices. Thus, from the distribution 208, the respective quality level may be extracted to obtain a final quality distribution 209, which may correspond to the distributions 204, 205. The respective data for the final quality distributions 209 may also be supplied to the model monitor 206, which may compare the distributions 205 with the distribution 209, in order to monitor the quality of the prediction of the models used for establishing the distribution 205. In some illustrative embodiments, the unit 207 may appropriately update the corresponding model upon detecting a significant deviation between the distributions 205 and 209. For this purpose, an appropriate adaptation of the corresponding transformation to the previously established transformation for a model may be modified on the basis of the degree of deviation, for which any appropriate data processing mechanism may be used.

FIG. 2h schematically illustrates a typical output of the model monitor 206. In FIG. 2h, the horizontal axis may represent the various die grades or die locations while the vertical axis represents a statistical metric of the deviation between the distributions 205 and 209, for instance in the form of a summed square error. As is illustrated, the corresponding deviation may be sufficiently small, thereby indicating a good match between the predicted distribution 205 and the actually measured distribution 209. Consequently, the model used for establishing the distribution 205 may reliably and in a robust manner reflect the “true” quality distribution, thereby also enabling a reliable and robust detection of factory disturbances.

As a result, the present disclosure provides an efficient system and technique for monitoring the dynamic behavior of a complex manufacturing environment with respect to the occurrence of disturbances by monitoring a change in the predicted quality distribution, thereby providing enhanced performance with respect to speed and accuracy in identifying factory disturbances compared to conventional strategies. By using a graded die forecast, it may no longer be necessary to track multiple electrical measurement parameters, which may lead to false alarms or missed signals, as previously explained. Furthermore, the occurrence of a factory disturbance may be automatically indicated with low delay with respect to critical manufacturing processes, thereby reducing the potential for inappropriate processing of substrates, which may result in increased overall yield while additionally providing enhanced flexibility in responding to external and internal demands.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method, comprising:
determining a first predicted quality distribution for a group of substrates prior to performing one or more manufacturing processes in a manufacturing environment, each of said substrates comprising a plurality of die regions;
obtaining electrical measurement data from one or more selected sample substrates of said group;
determining a second predicted quality distribution on the basis of said electrical measurement data; and
monitoring said manufacturing environment with respect to an occurrence of a disturbance by determining a deviation between said first and second predicted quality distributions.

2. The method of claim 1, wherein determining said second predicted quality distribution comprises using a model relating said electrical measurement data obtained by said one or more selected sample substrates to final electrical measurement data obtained from each of said substrates after completing said plurality of manufacturing processes.

3. The method of claim 1, wherein monitoring said manufacturing environment comprises determining a predicted yield metric for at least some die grades of the group of substrates and indicating a disturbance of said manufacturing environment when a deviation of said predicted yield metric of said first quality distribution from said predicted yield metric of said second quality distribution is greater than a predefined threshold.

4. The method of claim 3, wherein a predicted yield metric is determined for each die grade of said group of substrates.

5. The method of claim 2, further comprising comparing said second quality distribution obtained by said model with a final quality distribution obtained by using said final electrical measurement data.

6. The method of claim 5, further comprising updating said model when a result of said comparison is outside a predefined range.

7. The method of claim 1, further comprising updating said first quality distribution by using measurement data obtained from at least one of the plurality of manufacturing processes prior to determining said second predicted quality distribution.

8. The method of claim 2, further comprising building said model by using a weighted least squares regression of historical electrical measurement data.

9. The method of claim 8, wherein building said model comprises using historical measurement data relating to a predefined quality standard of semiconductor devices formed in said die regions.

10. The method of claim 9, wherein said predefined quality standard corresponds to fully operable semiconductor devices.

11. The method of claim 7, wherein updating said first quality distribution comprises using a second model that relates said measurement data to a predefined quality standard of semiconductor devices formed in said die regions.

12. The method of claim 11, further comprising comparing said updated first quality distribution with a final quality distribution obtained on the basis of final electrical measurement data from each substrate in said group and updating said second model when a deviation of said updated first quality distribution from said final quality distribution is greater than a predefined second threshold.

13. A method, comprising:
determining a predicted yield distribution for a process result of processing a group of substrates by performing a plurality of manufacturing processes in a manufacturing environment, each substrate comprising a plurality of semiconductor devices;
receiving electrical measurement data in a data processing system from selected samples of said group after performing said plurality of manufacturing processes;
updating said predicted yield distribution by using said electrical measurement data and a model implemented in said data processing system; and
comparing said predicted yield distribution and said updated predicted yield distribution to monitor said manufacturing environment with respect to the occurrence of a disturbance.

14. The method of claim 13, further comprising monitoring a prediction quality of said model by comparing said updated yield distribution with a final yield distribution generated from final electrical measurement data obtained from each substrate of said group.

15. The method of claim 14, further comprising updating said model on the basis of said final electrical measurement data when said prediction quality is below a predefined level.

16. The method of claim 14, wherein comparing said predicted yield distribution and said updated yield distribution comprises determining a summed squared error of the predicted yield distribution and said updated yield distribution.

17. The method of claim 13, wherein said predicted yield distribution is determined for a single quality standard of said semiconductor devices.

18. The method of claim 13, further comprising updating said predicted yield distribution at least once after performing a subset of said plurality of manufacturing processes.

19. A system, comprising:
an interface configured to connect to an automatic test equipment for receiving measurement data, said automatic test equipment providing electrical measurement data from substrates comprising semiconductor devices after completing a plurality of manufacturing processes;
a yield prediction unit connected to said interface and configured to update a predicted yield distribution associated with product substrates to be processed by said plurality of manufacturing processes by using electrical measurement data obtained from selected samples of said substrates; and
an evaluation unit connected to said yield prediction unit and configured to determine a deviation of an updated yield distribution generated by said yield prediction unit from a non-updated yield distribution.

20. The system of claim 19, further comprising a prediction quality monitor connected to said yield prediction unit and to said interface for receiving electrical measurement data from said automatic test equipment, wherein said prediction quality monitor is configured to determine a deviation of said updated predicted yield distribution from a final yield distribution on the basis of measurement data obtained from at least some additional substrates other than said samples.
